(19) United States
(12) Patent Application Publication
(10) Pub. No.: US 2008/0032537 A1
(43) Pub. Date: Feb. 7, 2008

(54) Socket connector for in-line modules

(75) Inventor: James Albert Leidy, Hummelstown, PA (US)

Correspondence Address: Robert J. Kapalka;Tyco Electronics Corporation, Suite 140, 4550 New Linden Hill Road, Wilmington, DE, 19808-2952, US

(73) Assignee: Tyco Electronics Corporation

(21) Appl. No.: 11/498,111

(22) Filed: Aug. 2, 2006

(51) Int. Cl. H01R 13/62

(52) U.S. Cl. 439/326

(57) ABSTRACT

A socket connector for connecting a card edge module to a circuit board includes a housing extending along a longitudinal axis between opposed ends. The housing includes a mounting face configured to be received on the circuit board and a mating face configured to receive a card edge module. Each of the opposed ends includes an end surface transverse to the mating face and the mounting face. A latch member is located at each of the opposed ends. The latch members engage a mounting feature on each of the end surfaces to mount the latch members to the housing.

### BACKGROUND OF THE INVENTION

The invention relates generally to sockets for retaining card edge modules and, more particularly, to a reduced width socket for memory modules.

Computers and servers may use numerous types of electronic modules, such as processor and memory modules (e.g. Dynamic Random Access Memory (DRAM), Synchronous Dynamic Random Access Memory (SDRAM), or Extended Data Out Random Access Memory (EDO RAM), and the like). The memory modules are produced in a number of formats such as, for example, Single In-line Memory Modules (SIMM's), or the newer Dual In-line Memory Modules (DIMM's), Small Outline DIMM's (SODIMM's) and Fully Buffered DIMM's. Typically, the modules are installed in one or more multi-pin sockets mounted on a system board or motherboard. Each memory module has a card edge that provides an interface generally between two rows of contacts in the socket. Conventionally, the card edge interface is a separable card edge interface.

At least some computer systems are modular rack mounted systems having segments, or modules that slide into the rack. The modular construction allows systems to be built to perform specific functions. In addition, some of the modules may be designed to adhere to certain standards, such as the Advanced Telecommunications Computing Architecture (ATCA), mezzanine card (AMC) standard, and micro TCA standard among others. The standards may address both electrical aspects as well as size aspects of the various components with the trend being toward smaller and more compact components. Typically, SODIMM sockets include latch arms that extend from cavities on the sides of the socket. Some such sockets may be too wide or more specifically, too long to allow the AMC module to be used in some rack mounted systems. Thus, there remains a need for an SODIMM socket connector having a sufficiently narrow profile that allows the use of conventional DIMM's with modules such as AMC compliant rack mounted modules.

### BRIEF DESCRIPTION OF THE INVENTION

In one aspect, a socket for connecting a card edge module to a circuit board is provided. The connector includes a housing extending along a longitudinal axis between opposed ends. The housing includes a mounting face configured to be received on the circuit board and a mating face configured to receive a card edge module. Each of the opposed ends includes an end surface transverse to the mating face and the mounting face. A latch member is located at each of the opposed ends. The latch members engage a mounting feature on each of the end surfaces to mount the latch members to the housing.

The connector further includes electrical contacts held in the housing. The contacts have mating ends proximate the mating face of the housing and mounting ends extending from the mounting face of the housing. The mounting face of the housing is substantially perpendicular to the mating face of the housing. The latch members each include a mounting end and the housing includes mounting receptacles configured to receive the mounting ends of the latch members. The latch members each include a clamping arm and the housing is disposed between the clamping arms.

In another aspect, a socket connector for connecting a card edge module to a circuit board is provided. The connector includes a housing extending along a longitudinal axis between opposed ends. The housing includes a mounting face configured for mounting on the circuit board and a slot configured to receive the card edge module. A latch member is connected to the housing for retaining the card edge module in the slot. The latch member has a mounting end secured to the housing and extending substantially parallel to the longitudinal axis.

In a further aspect, a socket connector for connecting a card edge module to a circuit board includes a housing extending along a longitudinal axis between opposed ends. The housing includes a mounting face configured to be received on the circuit board and a slot configured to receive the card edge module. A latch member is connected to the housing for retaining the card edge module in the slot. The latch member includes a mounting end. The housing has a mounting receptacle that is configured to receive the mounting end of the latch member in an installation direction that is substantially parallel to the longitudinal axis of the housing.

### BRIEF DESCRIPTION OF THE DRAWINGS

FIG. 1 is a perspective view of a socket connector formed in accordance with an exemplary embodiment of the present invention.

FIG. 2 is an exploded view of the socket connector shown in FIG. 1.

FIG. 3 is a perspective view of the socket connector of FIG. 1 with a card edge module loaded into the connector.

### DETAILED DESCRIPTION OF THE INVENTION

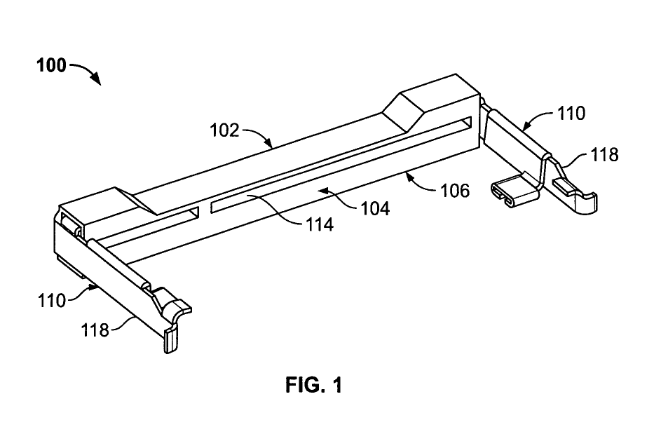

FIG. 1 illustrates a socket connector 100 formed in accordance with an exemplary embodiment of the present invention. The connector 100 includes a dielectric housing 102 having a forward mating face 104 and a mounting face 106. The mounting face 106 is substantially perpendicular to the mating face 104. A pair of latch members 110 is attached to the housing 102. The connector 100 is configured to be mounted on a circuit board (not shown in FIG. 1) at the mounting face 106 of the housing 102. The housing 102 includes a slot 114 that is configured to receive the mating edge of a card edge in-line electronic module (not shown in FIG. 1). Each latch member 110 includes a clamping arm 118 that retains the electronic module. The clamping arms 118 are disposed at opposite ends of the housing 102.

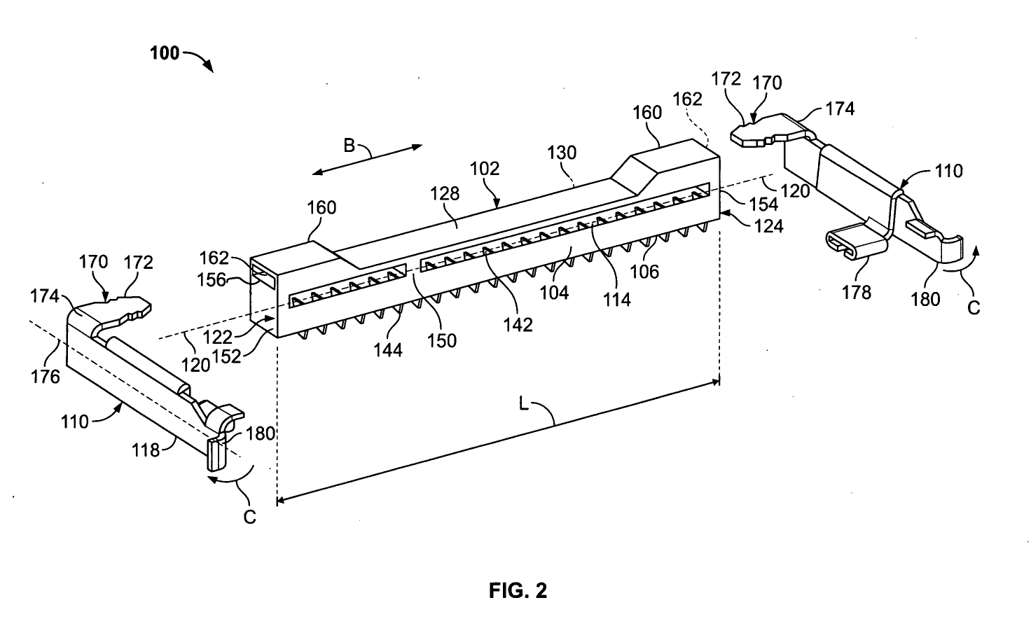

FIG. 2 illustrates an exploded view of the socket connector 100. The housing 102 extends along a longitudinal axis 120 between opposed ends 122 and 124. The housing 102 has a top surface 128, a rear surface 130, the front or mating face 104, and a mounting face 106 each of which also extends between the opposed ends 122 and 124. The housing 102 holds electrical contacts having mating ends 142 and mounting ends 144. The contact mating ends 142 extend into the slot 114 to electrically engage contact pads (not shown) on the electronic module when the electronic module is installed in the connector 100. The contact mounting ends 144 extend from the mounting face 106 in the direction of the arrow A and are configured to electrically connect to the circuit board upon which the connector 100 is mounted. In the exemplary embodiment, the contact mating and mounting ends 142, 144 are substantially perpendicular to one another. A key 150 is provided at an off-center position in the slot 114 and is received in a notch in the electronic module to assure that the electronic module is properly aligned with respect to the connector 100.

Opposed ends 122 and 124 includes surfaces 152 and 154 that are transverse to and face away from the mating face 104 and the mounting face 106. In some embodiments, the latch members 110 are in abutting engagement with the end surfaces 152 and 154 when the latch members 110 are mounted to the housing 102. The end surfaces 152 and 154 include a mounting feature engaged by the latch members 110 to enable mounting of the latch members 110 to the housing 102. In the illustrated embodiment, the mounting feature comprises an opening 156 that receives a portion of the latch members 110. In alternative embodiments, the mounting feature may comprise a mounting peg received in a hole in the latch member 110.

A mounting receptacle 160 is formed proximate each end 122 and 124 of the housing 102. Mounting receptacles 160 are provided for attachment of the latch members 110 to the housing 102. In the illustrated embodiment, the mounting receptacles 160 are disposed at an upper portion of the housing 102. That is, no additional dielectric material is placed at the ends 122 and 122 of the housing 102 for providing mounting receptacles, such as receptacles 160. Rather, by locating the mounting receptacles 160 at an upper portion of the housing, a length L of the housing 102 between the opposed ends 122, 124 can be minimized. Alternatively, the mounting receptacles 160 may be positioned at a rear portion of the housing 102. Each mounting receptacle 160 includes a cavity 162 for mounting of the latch members 110. The openings 156 on the end surfaces 152 and 154 open into the cavities 162.

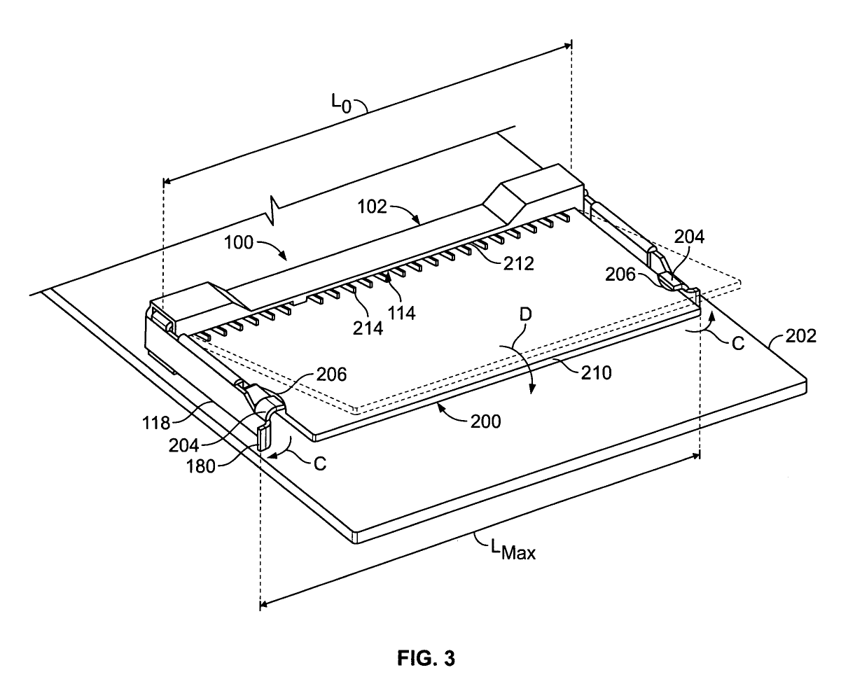

Each latch member 110 includes a mounting end 170. The mounting ends 170 are received in the cavities 162 in a mounting direction indicated by the arrow B, which is substantially parallel to the longitudinal axis 120, to mount the latch members 110 to the housing 102. The mounting ends 170 are provided with barbs 172 that frictionally engage the interior walls of the cavities 162 to retain the latch members 110. The latch members 110 are formed with a bend 174 between the clamping arms 118 and mounting ends 170 and the clamping arms 118 and mounting ends 170 are substantially perpendicular to one another. Each clamping arm 118 extends along a longitudinal axis 176 that is substantially perpendicular to the mounting direction of the mounting end 170 and the longitudinal axis 120 of the housing 102. Each latch arm includes a mounting foot 178 for mounting the connector 100 to the circuit board 202 (FIG. 3). In an exemplary embodiment, the mounting foot 178 is unitarily formed with the clamping arm 118. An end 180 of the clamping arm 118 is deflectable in the direction of the arrow C.

FIG. 3 is a perspective view of the socket connector 100 with a card edge electronic module 200 loaded therein. The connector 100 is mounted on a circuit board 202. The module 200 is connected to the circuit board 202 through the connector 100. The electronic module 200, in one embodiment, may be a Dual In-Line Memory Module (DIMM) or a Small Outline (SODIMM); however, no limitation is intended thereby. Alternatively, it is contemplated that the electronic module 200 may take other forms such as Single In-Line Memory Modules (SIMM) and other edge mounted modules. The electronic module 200 is loaded into the slot 114 of the socket connector 100 at an angle as shown in phantom outline and is rotated as indicated by the arrow D to its final loaded position. The ends 180 of the clamping arms 118 are deflected slightly in the direction of the arrow C as the electronic module 200 moves to its final loaded position. Locking elements 204 formed on the clamping arms 118 are received in notches 206 in the electronic module 200 when the electronic module 200 is finally loaded. The module 200 includes a substantially planar substrate 210 that has a mating edge 212 and a plurality of electrical traces, each of which terminates at a respective contact pad 214 on the mating edge 212. The substrate 210 may also include surface mounted components (not shown).

In the illustrated embodiment, the connector 100 is suitable for use with electronic modules meeting standards for an Advanced Telecom Computing Architecture (ATCA) mezzanine card (AMC). It is to be understood however, that in other embodiments, the connector 100 may be sized for other applications. With the latch member mounting design as described, the connector 100 is sufficiently narrow such that the connector 100 may be used in rack mounted AMC systems. In such applications, the length L (FIG. 2) of the housing 102 is about 67.98 millimeters, while the length L_{O} (FIG. 3) between outer surfaces of the clamping arms 118 at the housing 102 is about 68.1 millimeters. The length L_{MAX} (FIG. 3) between the clamping arm ends 180 is about 68.8 millimeters.

The embodiments thus described provide a DIMM socket suitable for use with rack mounted AMC modules. Receptacles for attachment of the latch members are located at an upper portion of the socket housing which allows the overall length of the socket to be reduced. In the exemplary embodiment, the receptacles are cavities located on the top surface of the socket housing. Optionally, the socket may be used with in-line card type modules other than memory modules. For example, the socket may be sized to receive a daughter card or mother board containing a variety of circuit components, each of which is encompassed within the term module as used herein.

While the invention has been described in terms of various specific embodiments, those skilled in the art will recognize that the invention can be practiced with modification within the spirit and scope of the claims.

What is claimed is:

1. A socket connector for connecting a card edge module to a circuit board, said socket connector comprising:
a housing extending along a longitudinal axis between opposed ends, the housing including a mounting face configured to be received on the circuit board and a mating face configured to receive the card edge module, each of said opposed ends including an end surface having a mounting feature that is directed transverse to said mating face and said mounting face; and
latch members located at said opposed ends, said latch members engaging corresponding said mounting features on said end surfaces to mount said latch members to said housing.

2. The socket connector of claim 1 further comprising electrical contacts held in said housing, said contacts having mating ends proximate said mating face of said housing and mounting ends extending from said mounting face of said housing.

3. The socket connector of claim 1, wherein said mounting face of said housing is oriented substantially perpendicular to said mating face of said housing.

4. The socket connector of claim 1, wherein each said latch member includes a mounting end and said housing includes mounting receptacles configured to receive said mounting ends of said latch members.

5. The socket connector of claim 1, wherein each said latch member includes a mounting end and a clamping arm formed substantially perpendicularly to said mounting end.

6. The socket connector of claim 1, wherein each said latch member includes a clamping arm and said housing is disposed between said clamping arms.

7. The socket connector of claim 1, wherein each said latch member includes a mounting end and said housing includes mounting cavities configured to receive said mounting ends of said latch members with a friction fit.

8. A socket connector for connecting a card edge module to a circuit board, said socket connector comprising:
a housing extending along a longitudinal axis between opposed ends, the housing including a mounting face configured for mounting on the circuit board and a slot configured to receive the card edge module; and
a latch member connected to the housing for retaining the card edge module in the slot, the latch member having a mounting end secured to the housing and extending substantially parallel to the longitudinal axis.

9. The socket connector of claim 8, wherein the mounting end is received in a mounting receptacle in the housing.

10. The socket connector of claim 9, wherein the mounting end is moved substantially parallel to the longitudinal axis during installation of the mounting end into the mounting receptacle.

11. The socket connector of claim 8 further comprising a second latch member connected to said housing, said latch members being connected at respective ones of said opposed ends of said housing.

12. The socket connector of claim 8, wherein said latch member includes a clamping arm formed substantially perpendicularly to said mounting end.

13. The socket connector of claim 8 further comprising a second latch member connected to said housing, said latch members being connected at respective ones of said opposed ends of said housing, and wherein each said latch member includes a clamping arm and said housing is disposed between said clamping arms.

14. A socket connector for connecting a card edge module to a circuit board, said socket connector comprising:
a housing extending along a longitudinal axis between opposed ends, the housing including a mounting face configured to be received on the circuit board and a slot configured to receive the card edge module;
a latch member connected to the housing for retaining the card edge module in the slot, said latch member including a mounting end; and
the housing having a mounting receptacle that is configured to receive said mounting end of said latch member in an installation direction that is substantially parallel to said longitudinal axis of said housing.

15. The socket connector of claim 14 further comprising a second latch member at the other of said opposed ends of said housing.

16. The socket connector of claim 14 further comprising electrical contacts held in said housing, said contacts having mating ends proximate said mating face of said housing and mounting ends extending from said mounting face of said housing.

17. The socket connector of claim 14, wherein said mounting face of said housing is substantially perpendicular to said mating face of said housing.

18. The socket connector of claim 14, wherein said latch member includes a clamping arm formed substantially perpendicularly to said mounting end.

19. The socket connector of claim 14 further comprising a second latch member at the other of said opposed ends of said housing and wherein each said latch member includes a clamping arm and said housing is disposed between said clamping arms.
